(19) United States
(12) Patent Application Publication
(10) Pub. No.: US 2007/0011926 A1
(43) Pub. Date: Jan. 18, 2007

(54) Little help address placard and support shelf

(76) Inventor: Edward Yniguez, Alta Loma, CA (US)

Correspondence Address: BUHLER ASSOCIATES;BUHLER, KIRK A., 1101 CALIFORNIA AVE., SUITE 208, CORONA, CA, 92881, US

(21) Appl. No.: 11/182,951

(22) Filed: Jul. 18, 2005

(51) Int. Cl. G09F 15/00

(52) U.S. Cl. 40/606.1

(57) ABSTRACT

An address placard that can be converted into a shelf is disclosed. The address placard may include features such as solar or external powered illumination of the address numbers where the illumination is either in front or behind the address. The address placard can be opened by depressing the placard, or by rotating the placard to an open condition. In the open condition, the shelf may include hooks or other components that can aid a person that may be carrying a number of packages. The address placard and shelf may further include an additional locked area or combination area that allows a concealed key to be stored. A writing surface may also be included to leave a note. A doorbell or signaling mechanism may also be included with the address placard that signals when the placard is opened or when a button is depressed within the placard.

### FIELD OF THE INVENTION

This invention relates to a combination address placard and support shelf. More particularly, the present invention relates to an address display system that a person can convert to a shelf without requiring the person to set down their packages. Once the shelf has been lowered, hooks and other attachments connected to the shelf allow the person to hang bags and place items onto the shelf. The shelf may further include front or back illumination of the street address, a surface for writing a message and a signaling device.

### BACKGROUND OF THE INVENTION

Several products have been patented to allow for a temporary shelf that can be attached to a wall. For most of these patents, the shelf is not intended for use with a house address, or the house address is not visible when the shelf is deployed, or deploying the shelf requires a person to have a free hand when they open the shelf. What is needed is a house address that can easily be converted to a shelf with minimal effort by a person.

W. Hancock U.S. Pat. No. 2,714,920 discloses a concealed wall seat. The wall seat is essentially a seat that is folded up against a wall. The seat can be folded down by a person to sit on. The shelf could also be used to place a house address on. While this patent provides a platform for setting items, it does not include an address placard, an illumination function, doorbell function or a location to retain a key or other items.

Shyu U.S. Pat. No. 5,007,190 discloses a solar house-number indicating device that stores solar energy during the day and uses the solar energy at night to illuminate the address of the house. While this invention provides a display of the address of the house, and a compartment for storing the battery and possibly other items, the device is not intended to provide a shelf that can support items purchased from a store, nor does the invention provide hooks or other attachments to hang bags or other items.

Hanson, Jr. U.S. Pat. No. 5,305,979 discloses an address plate that converts to a narrow shelf. While this invention converts from an address plate to a shelf, the shelf does not include solar powered illumination of the address, hooks or other attachments to hang items from, and when the shelf is lowered, the address is no longer visible. In addition, the invention does not include a storage place for keys or other items, or a location for mail to be placed.

Wilton U.S. Pat. No. 5,911,524 discloses an automated, Illuminated Address Display and Entrance Light. This invention is intended to provide illumination of both the address and the area around the address display unit. The invention further includes a photo switch that turns on the address light when it is dark, and may include a second switch or motion sensor to turn on a second set of lighting to illuminate the area around the address display. While this invention provides a display of the address of the house, and a compartment for a secondary light, the device does not include a shelf and is not intended to provide a shelf that can support items purchased from a store, nor does the invention provide hooks or other attachments to hang bags or other items.

What is needed is a simple to operate address placard that can be converted to a shelf by a person without requiring them to put down a package. The ideal device would further be optionally able to provide illumination of the address hooks or other apparatus to aid the person carrying packages. The proposed application satisfies these requirements.

### BRIEF SUMMARY OF THE INVENTION

It is an object of the proposed invention to provide an address placard with a deployable shelf for the storage or placement of items a person is carrying so they can locate keys or other items to open a door.

Another object of the invention is to provide the address with front or back illumination so the address can be visible at night or in dark conditions.

Another object of the invention is to provide lighting for the address that is charged with solar energy so the address and shelf can be installed without requiring any additional wiring.

Another object of the invention is to provide the shelf that can be opened with a person pressing the shelf to allow a person to open the shelf without requiring them to free a hand to open the shelf.

Another object of the invention is to provide illumination of the address only when ambient light conditions require that the light be illuminated.

Another object of the invention is to provide the shelf that is transparent such that the address can be shown with the shelf in both the up and down position so the address can still be viewed when the shelf is in the down position.

Another object of the invention is to provide storage for mail that is not affected by the position of the shelf.

Another object of the invention is to provide hooks and or other paraphernalia that allows a person to hang items from the shelf in addition to providing a shelf for items that must be placed in an upright orientation such as drinks or plants.

Another object of the invention is to provide a deployable horizontal surface with recesses that reduce the possibility of movement of object on the horizontal surface.

Another object of the invention is to provide an additional secret or combination locked compartment that can be used to store keys or other items that may be of use.

Another object of the invention is to provide a signaling mechanism such as a doorbell or other signaling device that will let people within the address know that the shelf has been deployed.

Another object of the invention is to provide a writing surface so a person can leave a note for package delivery or other information.

Still another object of the invention is to provide a shelf that can be opened by the use of a voice or sound command that deploys the shelf using a word such as “Open” or “Help”.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is an isometric view of the address placard and support shelf with a solid door shown in the closed position.

FIG. 2 is an isometric view of the address placard and support shelf with a solid door shown in the open position.

FIG. 3 is an isometric view of the address placard and support shelf with a transparent door shown in the closed position.

FIG. 4 is an isometric view of the address placard and support shelf with a transparent door shown in the open position.

FIG. 5 is an isometric view of the tall address placard and support shelf with a tubular shelf shown in the up position.

FIG. 6 is an isometric view of the tall address placard and support shelf with a tubular shelf shown in the down position.

FIG. 7 is an isometric view of the wide address placard and support shelf with a tubular shelf shown in the up position.

FIG. 8 is an isometric view of the wide address placard and support shelf with a tubular shelf shown in the down position.

### DETAILED DESCRIPTION

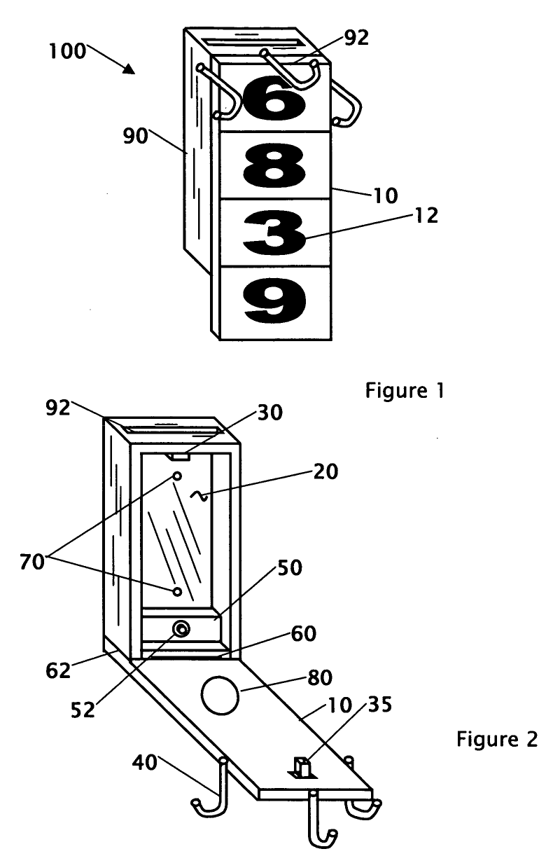

Referring to FIGS. 1 and 2 there is shown isometric views of the address placard and support shelf 100 with a solid door shown in the closed and opened positions respectively. Depending upon the configuration of the product, the address placard and support shelf can provide a number of different features and functions. In the configuration shown in FIGS. 1 and 2, the door 10 is a solid door that is not transparent. The address placard and support shelf is intended for use at a house, apartment, business or any location where an address is required. One of the main benefits of this product is to provide a deployable support shelf 10 so a person what is carrying items can deploy the shelf and place or hang items onto the shelf so the items are not placed onto the ground. In the embodiment shown, the address consists of four numbers 12 that indicate the address. While four numbers are shown, more or less numbers can be used, as well as letters, words, or a combination thereof. The construction of the address placard and support shelf consists of an enclosure 90. In the preferred embodiment, the enclosure is constructed from wood, but the construction of the enclosure can be from any material including but not limited to wood, metals, plastics or a combination thereof. A slot 92 may be included on the top or side of the enclosure to allow the address placard and support shelf to also be used as a mailbox to provide additional function to the address placard and support shelf. Refer more specifically to FIG. 2, that shows the address placard and support shelf in an open configuration to provide detail on some of the internal or inside 20 features and functions of the address placard and support shelf. The back or inside of the enclosure may also include a caulk board, note paper, note pad, white board or other similar writing surface that can be used to write a note for someone. The note may include instructions for leaving a package or for a child that leaves a note for his mother telling her that he went to a friend's house.

FIG. 2 also shows hooks 40 that have been added to three sides of the door to allow a person to hang bags or other items they may be carrying. While three hooks are shown as few as one hook can be used, or as many as desired. The address placard and support shelf is held onto a wall using screws or other similar hardware 70 that is capable of retaining the address placard and support shelf onto a wall when the address placard and support shelf is loaded with bags or other material. With the door 10 in the open position, as shown in this figure, the door is placed in a substantially horizontal position and a horizontal surface is formed. This horizontal surface is used for placement of items that must be placed in a particular orientation such as a cup of coffee or soda that may spill if tipped over. A recess 80 provides placement of this type of item and further provides additional stability for the cup or other similar items. While only one round recess is shown, more than one recess can be provided, and the shape may be square, rectangular or spherical. A hinge 60 provides the rotational movement of the front door. When the door is rotated into the horizontal configuration the bottom portion of the door 62 makes contact with the underside of the housing and prevents further rotation of the door as well as support for the shelf. A latch 30, with its corresponding counterpart 35, is shown in this figure. The latch may also trigger an alarm within the house or at the address placard and support shelf. This alarm may notify people within the house that someone has arrived with packages and requires some assistance.

A sensor within the enclosure may sense the presence of someone near the address placard and support shelf and may allows the address placard and support shelf to automatically open based upon the proximity of a person. It is further contemplated that the address placard and support shelf may have a sound or voice sensor that can operate with a person says “help” or “open”.

The latch may be a variety of types that allow the door to be held in a closed and an open position with minimal effort to open the door. In the preferred embodiment, the latch is a magnetic or spring open door where a user can press into the address placard and support shelf with a shoulder or arm, and the door is automatically opened allowing the user to use the shelf without the need to place down a package to open the support shelf. An internal compartment 50 is alternately provided in the address placard and support shelf. The internal compartment can include a lock 52 for securing items within the address placard and support shelf. In the configuration shown the compartment is visible when the door is in the open or deployed configuration, but the compartment can be configured, as a false backing that is not obvious.

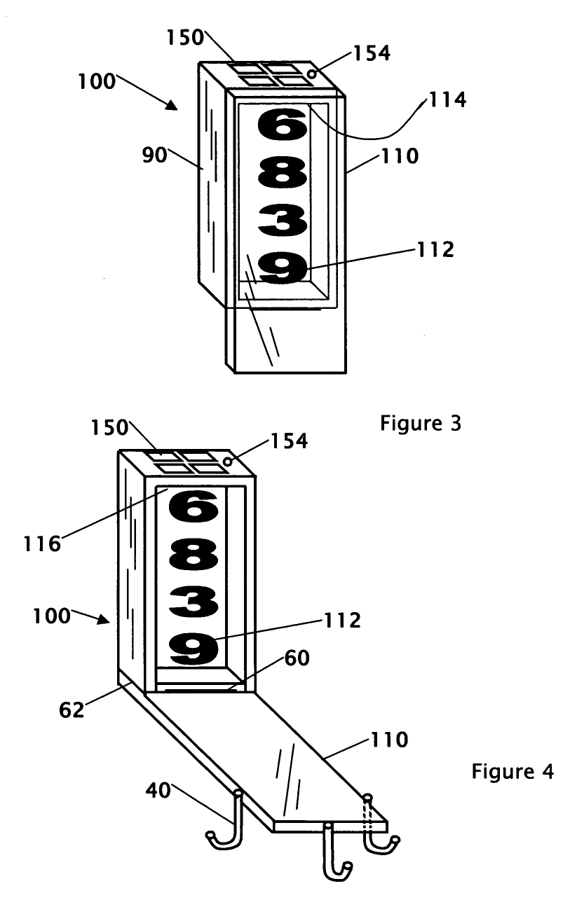

Referring to FIGS. 3 and 4 there is shown isometric views of the address placard and support shelf 100 with a transparent door shown in the closed and opened positions respectively. This configuration provides that additional benefit of allowing the address to be shown with the support shelf placed in either orientation. The address numbers 112 are recessed into the housing 90 behind the transparent door 110. Solar collectors 150 are shown in the top of the housing. While the collectors are shown on the top of the housing, they could also be placed on the side of the housing, or in any orientation that provides solar energy. The solar collectors charge a battery or other electrical storage device. A solar sensor 154 is located on the housing to connect power from the batteries to a light source 114 that illuminates the address. The light may also be illuminated with the door is opened. A hinge 60 provides the rotational movement of the front door. When the door is rotated into the horizontal configuration the bottom portion of the door 62 makes contact with the underside of the housing and prevents further rotation of the door as well as support for the shelf. Hooks 40 that have been added to three sides of the door to allow a person to hang bags or other items they may be carrying.

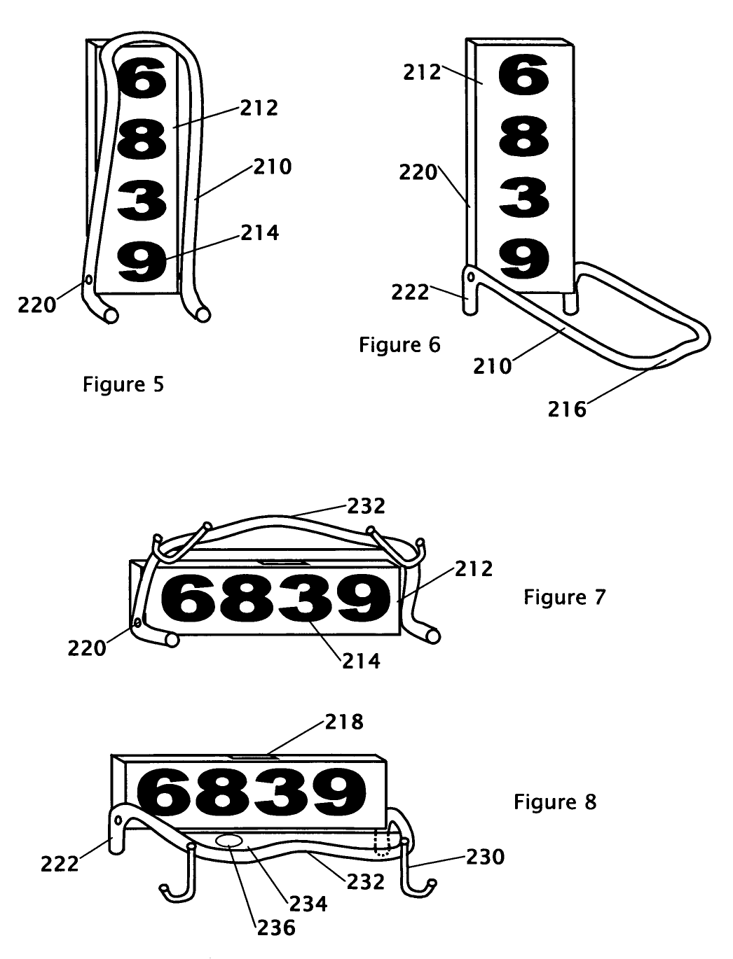

FIGS. 5-8 show the address placard a tubular rotatable deployable shelf. FIGS. 5 and 6 show this configured of the placard 212 with vertical arranged address number 214, while FIGS. 7 and 8 show the configuration of the placard 212 with horizontally arranged address numbers 214. In this simplified version a tube or similar member wraps around the address placard 212. A shelf 236 is shown in FIGS. 7 and 8 that can exist above the address numbers or could exist over the address numbers if the shelf was transparent. A cup holder 234 is shown as a circular cutout in FIG. 8. The tube 210 is secured to the placard with a pivot bearing 220 configured to allow the shelf to be rotated into a vertical orientation and horizontal orientation. When the shelf is rotated into a horizontal orientation the ends of the tube 220 make contact with the wall, and prevent additional rotation of the shelf. The tube may have an upward 216 bend that allows items to be held onto the bend of the tube. The tube may also have one or more hooks 230 to better allow holding of bags or other items that may have a loop. A storage cavity 218 may be incorporated within the placard. This cavity may allow for storage of a spare set of keys or other items. The storage cavity is shown here oriented on the top of the placard, but the cavity may be incorporated on a bottom, side or on the back of the placard to make it less visible.

Thus, specific embodiments and applications for an address display and support shelf to assist a person with bags have been disclosed. It should be apparent, however, to those skilled in the art that many more modifications besides those described are possible without departing from the inventive concepts herein. The inventive subject matter, therefore, is not to be restricted except in the spirit of the appended claims.

What is claimed is:

1. A combination address display and deployable shelf comprising:
a wall mountable elongated enclosure having a outside area and an inside area; where
the outside area includes a surface for mounting an address;
a deployable hinged side of the elongated enclosure such that the hinged side can be oriented in an essentially horizontal orientation; and
the horizontal surface includes at least one hooked member to allow a user to place handles of bags onto the at least one hooked area and additional items onto the essentially horizontal surface.

2. The combination address display and deployable shelf from claim 1 that further includes a storage cavity within the inside area for storing items or mail.

3. The combination address display and deployable shelf from claim 1 that further includes a battery or solar powered illumination feature for illuminating the address.

4. The combination address display and deployable shelf from claim 1 wherein the deployable-hinged side can be deployed by depressing at least a portion of the deployable-hinged side.

5. The combination address display and deployable shelf from claim 1 wherein the horizontal surface includes at least one recess for reducing movement of an item placed within the recess.

6. The combination address display and deployable shelf from claim 1 that further includes a signaling or alarm function that is activated by movement of the deployable-hinged side.

7. The combination address display and deployable shelf from claim 1 that further includes a temporary or permanent writing surface for leaving a note or message.

8. A combination address display and deployable shelf comprising:
a wall mountable enclosure having a outside area and an inside area separated by a hinged transparent door; where
the inside area includes a surface for mounting an address;
the hinged transparent door can be oriented in either an essentially vertical or horizontal orientation leaving the address visible; and
the horizontal surface allows a user to place items.

9. The combination address display and deployable shelf from claim 8 that further includes an additional storage cavity that may further include a locking feature.

10. The combination address display and deployable shelf from claim 8 that further includes a battery or solar powered illumination feature for illuminating the address.

11. The combination address display and deployable shelf from claim 8 wherein the deployable-hinged side can be deployed by depressing at least a portion of the deployable-hinged side.

12. The combination address display and deployable shelf from claim 8 that further includes a signaling or alarm function that is activated by movement of the transparent door.

13. The combination address display and deployable shelf from claim 8 that further includes at least one hook feature for holding bags or other looped items.

14. The combination address display and deployable shelf from claim 1 that further includes a temporary or permanent writing surface for leaving a note or message.

15. An address display with a rotatable rail comprising:
a wall mountable address display for displaying the address of a business or residence; and
a vertically to horizontally rotatable rail support structure for the support of packages or items wherein the address is visible with the rotatable rail in any orientation.

16. The address display with a rotatable rail from claim 15 that further includes a battery or solar powered illumination feature for illuminating the address.

17. The address display with a rotatable rail from claim 15 wherein the rotatable rail support can be rotated by depressing at least a portion of the rotatable rail support.

18. The address display with a rotatable rail from claim 15 that further includes a signaling or alarm function that is activated by movement of the rotatable rail.

19. The address display with a rotatable rail from claim 15 that further includes an additional storage cavity.

20. The address display with a rotatable rail from claim 15 that further includes at least one hook feature for holding bags or other looped items.
